(19) United States
(12) Patent Application Publication
(10) Pub. No.: US 2010/0092793 A1
(43) Pub. Date: Apr. 15, 2010

(54) Peelable Films Containing Nano Particles

(76) Inventors: Dinesh Aithani, Chesapeake, VA (US); Dena Briggs, Greenfield, MA (US)

Correspondence Address: MCANDREWS HELD & MALLOY, LTD, 500 WEST MADISON STREET, SUITE 3400, CHICAGO, IL, 60661, US

(21) Appl. No.: 12/493,839

(22) Filed: Jun. 29, 2009

Related U.S. Application Data
(63) Continuation of application No. PCT/US07/89028, filed on Dec. 28, 2007.
(60) Provisional application No. 60/878,022, filed on Dec. 29, 2006.

(51) Int. Cl. B32B 27/36; B32B 27/08; B32B 27/32; B29C 47/00; B29C 47/06; C08K 3/34

(52) U.S. Cl. 428/483; 428/516; 428/500; 264/176.1; 264/173.16; 524/445

(57) ABSTRACT

The present technology relates generally to peelable films and processes for making peelable films. The present technology also relates to peelable layers in films, and packages or lid stock that incorporate peelable films. In some embodiments, the present technology relates to peelable layers of monolayer or multilayer films that comprise at least one base polymer or copolymer and a nanoclay. In some embodiments, the at least one base polymer or copolymer comprising ethylene homopolymers, ethylene copolymers, propylene homopolymers, propylene copolymers, blends thereof, and mixtures thereof. Further, in some embodiments, the nanoclay is from about 1% to about 25% by weight of the peelable layer of a peelable seal film.

### RELATED APPLICATIONS

This application is a continuation of PCT/US07/89028, Publication No. 2008/127485, filed on Dec. 28, 2007, which claims priority to and benefit from U.S. Provisional Application Ser. No. 60/878,022, filed on Dec. 29, 2006.

### FIELD OF THE INVENTION

The present technology relates generally to peelable films for use in packaging, peelable layers in films, processes for making peelable films, and packages that incorporate peelable films. More particularly, the present technology relates to peelable layers of monolayer or multilayer films that incorporate nanoclay.

### BACKGROUND OF THE INVENTION

Peelable films and peelable packaging are used in a variety of packaging applications, such as packaging for food, medical, personal care, industrial, and agricultural items.

Peelable films are often used to provide peelable seals in packaging that opens easily in a predetermined manner without damaging or tearing the remaining materials, and without having to use a cutting edge. Such peelably sealed packaging includes, for example, flexible film lidding or lid stock material that may be peelably adhered to a container such as a tray, a cup, or a tub. In some such applications, the container may have a flange around the upper perimeter thereof to which a lid comprising a peelable seal film is peelably sealed. Other types of peelably sealed packaging include pouches, box liners, or bags containing a packaged product. In such applications, a pouch or bag is formed wherein the peelable film is sealed to itself or to another film, web, backing or other substrate.

Peelable films can be monolayer or multilayer films. The layer of a peelable film that facilitates the peelable seal and/or can be peelably removed is generally referred to as the “peelable layer,” or “separation layer” of the film. When the peelable layer is an outer sealant layer of the film, such a layer can also be referred to as a “peelable sealant layer.” When the peelable film is a monolayer film, the peelable layer and the peelable film are, in essence, the same. When the peelable film is a multilayer film, the peelable layer can be an outer layer of the film or an internal layer within the film structure.

In film structures where the peelable layer is an outer layer of the film, the peelable layer can be sealed to itself, or to another substrate such as another film, a web, a backing, or a container. When a portion of such a peelable seal film is grasped and pulled with sufficient manual force, the peelable seal “fails” and the peelable seal film separates from, and can be peeled away from, the substrate to which it is attached. This is sometimes referred to as a “surface peel” or “interfacial peel.”

In film structures where the peelable layer is an internal layer, the peelable layer can be peeled away from the other layers of the film, concurrently removing any layers that were on top of the peelable layer in the film structure. This type of structure results in what is generally referred to as a “delamination peel,” where one or more layers of the film can be peeled away from the other layers. Such films are sometimes used, for example, to peel oxygen-impermeable film layers away from an oxygen-permeable film at a desired time after a product, such as fresh meat, is sealed in the packaging. Such films can also be used in lidstock applications where a surface sealant layer bonds to a substrate, such as a container, and the peelable layer is an internal layer within the film structure that “fails” upon the exertion of manual peeling force.

One method currently used in the industry for producing peelable layers of films is based upon blending polybutylene with ethylene homopolymer and/or copolymer. Current peelable seal technology based upon the use of polybutylene utilizes the inherent incompatibility of the polymers in the peelable layer, which inhibits the peelable layer from forming a complete bond by reducing the number of available bonding sites.

For example, U.S. Pat. No. 6,630,237, issued on Oct. 7, 2003 to Rivett, et al., describes films having a peelable layer that includes a blend of: i) from about 3 to about 15 weight parts polybutylene, ii) from about 40 to about 75 weight parts ionomer, and iii) from about 20 to about 55 weight parts ethylene/unsaturated ester copolymer such as a vinyl ester of aliphatic carboxylic acid or an alkyl ester of acrylic or methacrylic acid. As described in U.S. Pat. No. 6,630,237, the polybutylene in the blend acts as a “contaminant” or “incompatible” component to enhance the peelability of the peelable layer by weakening the seal between the peelable layer and the adjacent layer or substrate.

Peelable layers can also be obtained by using some incompatible blends such as polyethylene and polypropylene, or polyethylene and ionomer, in the sealant layer. For example, European Patent EP 0765742 B1, to PCD Polymers Gesellschaft m.b.H., in Austria, describes a peelable sealant layer comprising a mixture of C₂-C₃ random copolymers or highly amorphous polypropylene polymers with an ethylene polymer.

Peelable layers made using polybutylene or incompatible blends tend to have drawbacks with respect to various seal properties. For example, polybutylene based technology for peelable seals has an ageing effect, wherein the seal strength decreases over time, and does not provide consistent seal strength with varied sealing temperature. As another example, peelable films based upon incompatible blends tend to have limited temperature ranges at which they can be heat sealed, and tend to exhibit variation in seal strength with changing temperatures.

There is therefore a need for a peelable seal technology that provides consistent seal strength, particularly at various sealing temperatures. Further, there is a need for peelable seal technology that provides stable seal strength over time.

### BRIEF SUMMARY OF THE INVENTION

The present technology relates generally to peelable seal films, peelable layers in films, processes for making films having peelable layers, and packages or lid stock that incorporate films having peelable layers. More particularly, the present technology relates to peelable film layers that provide improved peel seal properties obtained by incorporating nanoclay into the peelable layer of a film. Peelable seals of the present technology can be formed by mechanical sealing, heat sealing, radio frequency sealing, or ultra-sonic sealing. Peelable films and peelable packaging in accordance with the present technology can be used in a variety of applications, such as packaging for food, medical, personal care, industrial, or agricultural items.

In one aspect, the present technology provides a peelable film layer comprising at least one base polymer or copolymer selected from ethylene homopolymers, ethylene copolymers, propylene homopolymers, propylene copolymers, blends thereof, or mixtures thereof; and at least one nanoclay. In some embodiments, the peelable layer forms a peelable seal with a substrate. Further, in some embodiments, the peelable film layer further comprises at least a one additional polymer or copolymer.

For example, in at least one such embodiment, the peelable film layer comprises at least one base polymer or copolymer comprising a linear low density polyethylene (LLDPE), a low density polyethylene (LDPE), a medium density polyethylene (MDPE), an ethylene vinyl acetate (EVA), an ethylene methyl acrylate (EMA), an ethylene methacrylic acid polymer (EMAA), an ethylene acrylic acid (EAA), an ionomer, a high density polyethylene (HDPE), a single site catalyzed polymer, a plastomer, an ionomer, a blend thereof, or a mixture thereof; at least one additional polymer or copolymer comprising a linear low density polyethylene (LLDPE), an ultra low density polyethylene (ULDPE), a cyclic olefin copolymer (COC), a single site catalyzed polymer, a plastomer, an ionomer, a blend thereof, or a mixture thereof; and at least one nanoclay in an amount from about 1% to about 25% by weight of the film layer. In one embodiment, at least one base polymer is from about 25% to about 98% by weight of the film layer and at least one additional polymer or copolymer is from about 1% to about 50% by weight of the film layer. In another embodiment, at least one base polymer is from about 70% to about 90% by weight of the film layer, at least one additional polymer or copolymer is from about 5% to about 15% by weight of the film layer, and at least one nanoclay is from about 5% to about 15% by weight of the film layer.

In another aspect, the present technology provides a peelable film comprising at least one peelable layer, wherein the peelable layer comprises at least one base polymer or copolymer and at least one nanoclay, wherein at least one polymer or copolymer is selected from ethylene homopolymers, ethylene copolymers, propylene homopolymers, propylene copolymers, mixtures thereof, or blends thereof. In preferred embodiments, the amount of nanoclay is from about 1% to about 25% by weight of the peelable layer.

In a third aspect, the present technology provides processes for making a peelable film. In some embodiments of such processes, the peelable blend contains from about 1% to about 25% by weight of nanoclay. In one embodiment, a process is provided involving the steps of providing at least one nanoclay; providing at least one base polymer or copolymer; blending or compounding the at least one nanoclay and at the least one base polymer or copolymer to form a peelable blend; and extruding the peelable blend to form a peelable film or a peelable film layer. In some preferred embodiments, the process further comprises the step of compounding or blending at least one additional polymer or copolymer with the at least one nanoclay and at the least one base polymer or copolymer to form the peelable blend. In an alternative embodiment, the present technology provides a process for making a peelable film involving the steps of providing a predispersed nanoclay comprising nanoclay dispersed in at least one polymer or copolymer; and extruding the predispersed to form a peelable seal film or a peelable film layer. In some preferred embodiments, the process further comprises the step of compounding or blending at least one additional polymer or copolymer with the predispersed nanoclay.

In a fourth aspect, the present technology provides packages having a peelable layer. In one embodiment, the present technology provides a package comprising at least one substrate comprising at least one seal surface and at least one peelable seal film comprising a peelable sealant layer. In such embodiments, the peelable sealant layer comprises at least one base polymer or copolymer selected from ethylene homopolymers, ethylene copolymers, propylene homopolymers, propylene copolymers, blends thereof, or mixtures thereof; and at least one nanoclay. Further, in such embodiments, the peelable sealant layer of the peelable seal film forms a peelable seal with the at least one seal surface of at least one substrate. In another embodiment, the present technology provides a package comprising at least one substrate comprising at least one seal surface and a multilayered film comprising a sealant layer and a peelable layer. In such embodiments, the peelable layer comprises at least one base polymer or copolymer selected from ethylene homopolymers, ethylene copolymers, propylene homopolymers, propylene copolymers, blends thereof, or mixtures thereof; and at least one nanoclay. Further, in such embodiments, the sealant layer of the multilayer film is sealed to at least one seal surface of at least one substrate, and at least the peelable layer of the multilayer film can be removed by the application of manual force. Other layers that are coextruded or laminated to the peelable layer can be removed as well.

The present peelable film technology provides a more consistent seal strength and has less of an ageing effect as compared to conventional peelable technologies utilizing polybutylene or incompatible blends. While not being bound by any particular theory, it is believed that the incorporation and dispersion of nanoclay into a peelable layer is believed to reduce the polymer-polymer interaction in the peelable layer. Thus, an improved seal strength and/or aging profile can be achieved with peelable layers and peelable films of the present technology.

### BRIEF DESCRIPTION OF SEVERAL VIEWS OF THE DRAWINGS

FIG. 1 is a graph showing the measured seal strengths of two peelable seal test samples of the present technology at various sealing temperatures.

FIG. 2 is a graph showing the measured seal strengths of a polybutylene based peelable seal test sample at various sealing temperatures, as measured within a minute of film cooling after seal formation and one month after seal formation.

FIG. 3 is a graph showing the measured seal strengths of a peelable seal test sample of the present technology at various sealing temperatures, as measured within a minute of film cooling after seal formation and one month after seal formation.

FIG. 4 is a graph showing the measured seal strengths of a peelable seal test sample of the present technology at various sealing temperatures, as measured within a minute of film cooling after seal formation and one month after seal formation.

FIG. 5 is a graph showing the measured seal strengths of a peelable seal test sample of the present technology at various sealing temperatures, as measured within a minute of film cooling after seal formation and one month after seal formation.

FIG. 6 is a graph of the measured seal strength for four peelable seal test samples of the present technology at various sealing temperatures.

FIG. 7 is a graph of the measured seal strength for four peelable seal test samples of the present technology at various sealing temperatures.

### DETAILED DESCRIPTION OF THE INVENTION

The present technology relates generally to peelable films, peelable layers in films, processes for making peelable films, and packages that incorporate peelable films. More particularly, the present technology relates to improved peelable layers in films that can be obtained by introducing nanoclay, such as organically modified nanoclay, into the sealant layer of a film.

### Peelable Seal Compositions and Sealant Layers

Peelable layer compositions for peelable films and peelable film layers of the present technology comprise at least one base polymer or copolymer and at least one nanoclay. Base polymers and copolymers of the present technology can be, for example, ethylene homopolymers, ethylene copolymers, propylene homopolymers, propylene copolymers, blends thereof, or mixtures thereof. For example, in at least one embodiment, the present technology provides a peelable layer composition comprising at least one base polymer or copolymer selected from ethylene homopolymers, ethylene copolymers, propylene homopolymers, propylene copolymers, blends thereof or mixtures thereof; and at least one nanoclay.

More preferably, base polymers and copolymers of the present technology comprise a linear low density polyethylene (LLDPE), a low density polyethylene (LDPE), a medium density polyethylene (MDPE), an ethylene vinyl acetate (EVA), an ethylene methyl acrylate (EMA), an ethylene methacrylic acid polymer (EMAA), an ethylene acrylic acid copolymer (EAA), an ionomer, a high density polyethylene (HDPE), a single site catalyzed polymer, a plastomer, a blend thereof, or a mixture thereof.

In some embodiments, compositions for peelable seal films and peelable layers of the present technology further comprise at least one additional polymer or copolymer. In such embodiments, the at least one additional polymer or copolymer preferably comprises a linear low density polyethylene (LLDPE), an ultra low density polyethylene (ULDPE), a cyclic olefin copolymer (COC), a single site catalyzed polymer, a plastomer, an ionomer, a blend thereof, or a mixture thereof.

Low density polyethylene (LDPE) and medium density polyethylene (MDPE) are branched polyethylenes. Branched polyethylenes generally have a density of from about 0.910 g/cm³ to about 0.940 g/cm³, and a crystallinity level of from about 40% to about 60%. In some contexts, the term low density polyethylene is used to refer to a branched polyethylene having a density of from about 0.910 g/cm³ to about 0.940 g/cm³. More particularly, however, the term low density polyethylene (LDPE) is often used to refer to branched polyethylene having a density of from about 0.910 g/cm³ to about 0.925 g/cm³ and the term medium density polyethylene (MDPE) is used to refer to branched polyethylene having a density of from about 0.925 g/cm³ to about 0.940 g/cm³. The terms LDPE and MDPE are used in such a manner herein. Further discussion of LDPE and MDPE can be found, for example, in Plastics Packaging by Hernandez, Selke and Cutler, © Carl Hanser Verlag, Munich 2000, at pp. 91-92, the content of which is hereby incorporated by reference.

Linear polyethylenes are often divided into several categories based upon their density, such as ultra low density polyethylene (ULDPE), linear low density polyethylene (LLDPE), and high density polyethylene (HDPE). Some linear polyethylenes can have a crystallinity level of from about 70% to about 90%. Some linear polyethylenes are made using Ziegler-Natta catalyst technology, which can decrease crystallinity and lower density. ULDPE can also be referred to as very low density polyethylene (VLDPE), and the terms should be understood herein as being interchangeable. ULDPE generally has a density of from about 0.89 g/cm³ to about 0.915 g/cm³. LLDPE generally has a density of from about 0.916 g/cm³ to about 0.940 g/cm³. HDPE generally has a density of from about 0.940 g/cm³ to about 0.965 g/cm³. Further discussion of linear polyethylenes can be found, for example, in Plastics Packaging by Hernandez, Selke and Cutler, at pp. 91, 95-99, the content of which is hereby incorporated by reference.

Ethylene vinyl acetate (EVA) is a random copolymer produced by copolymerizing ethylene and vinyl acetate monomers. The properties of EVA depend upon its content of vinyl acetate and its molecular weight. For example, as the vinyl acetate content increases, the crystallinity decreases and the density increases. EVA copolymers with vinyl acetate contents ranging from about 5% to about 50% are commercially available, and are suitable for use with the present technology. For food applications, vinyl acetate contents of from about 5% to about 30% are generally recommended. Further discussion of EVA can be found, for example, in Plastics Packaging by Hernandez, Selke and Cutler, at pp. 92-93, the content of which is hereby incorporated by reference.

Ethylene methyl acrylate (EMA) is produced by copolymerizing ethylene and methyl acrylate monomer. EMA having from about 9% to about 25% methyl acrylate by weight is commercially available, and is suitable for use with the present technology. Further discussion of EMA can be found, for example, in Film Extrusion Manual, by Thomas I. Butler, second edition, © 2005 Tapri Press, Technology Park, Atlanta, at pp. 483-85, the content of which is hereby incorporated by reference.

Ethylene methacrylic acid polymer (EMAA) is produced by copolymerizing ethylene and methyl acrylic acid. Ethylene acrylic acid (EAA) is produced by copolymerizing ethylene and acrylic acid. Ethylene acrylic acids can contain different amounts of acrylic acid. Generally, as the acrylic acid content increases, the crystallinity decreases. Decreases in crystallinity tend to result in an increase in adhesion strength and a decrease in the heat seal temperature. Further discussion of EAA can be found, for example, in Plastics Packaging by Hernandez, Selke and Cutler, at pp. 93-94, the content of which is hereby incorporated by reference. Further discussion of EMAA and EAA can also be found, for example, in Film Extrusion Manual, by Thomas I. Butler, second edition, pp 487-90, the content of which is hereby incorporated by reference.

Ionomers are formed by the neutralization of copolymers such as EAA or EMAA with cations. Typically utilized cations include, for example, sodium, (Na⁺), zinc (Zn⁺⁺), Lithium (Li⁺), and the like. Ionomers suitable for use with the present technology include, but are not limited to the Surlyn® product line commercially available from DuPont.

Single site catalyzed polymers are polymers produced by using a single site catalyst. The use of single site catalyst is believed to provide better control of comonomer distribution, and provide a narrower molecular weight distribution. Utilization of a single site catalyst generally results in better polymer properties than utilization of a conventional catalyst. One single site catalyzed polymer that is particularly preferred for use with the present technology is metallocene based LLDPE (mLLDPE). Examples of commercially available single site catalyzed polymers suitable for use with the present technology include, but are not limited to Dow Elite® single site catalyzed polymers, Exxon Exceed® single site catalyzed polymers, Chevron Marflex® single site catalyzed polymers, Chevron MPact® mLLDPE, Nova Sclair® single site catalyzed polymers, and SclairTech® mPE resins.

Plastomers are ethylene/alpha-olefin copolymers that generally have properties in between plastics and elastomers. They are produced using a single site catalyst and have a density in the range of about 0.86 g/cc to about 0.91 g/cc. Commercially available plastomers suitable for use with the present technology include, but are not limited to, Dow Affinity® plastomers, and Exxon Exact® plastomers.

Cyclic olefin copolymer (COC) can be used as an additional copolymer in compositions of the present technology. COCs are amorphous, transparent copolymers based on cyclic and linear olefins. COCs suitable for use with the present technology include, but are not limited to Topas® COCs, available from Topas Advanced Polymers. Topas® COCs are made from ethylene and norbornene.

The amounts of each compositional component in peelable compositions, film layers and films of the present technology can vary depending upon the particular structure and application of the desired end use peelable seal film. For example, in embodiments where the peelable films and peelable layers of the present technology comprise at least one base polymer or copolymer and at least one nanoclay, the amount of base polymer can be any amount from about 75% to about 99% by weight of the composition of the peelable layer. The amount of base polymer can be, for example, about 75%, about 77%, about 80%, about 83%, about 85%, about 87%, about 90%, about 93%, about 95%, about 97%, about 98%, or about 99% by weight of the composition of the peelable layer. Preferably, the base polymer is from about 85% to about 95% by weight of the composition of the peelable layer, and more preferably from about 87% to about 93% by weight of the composition of the peelable layer.

In embodiments where the peelable seal films and peelable layers of the present technology comprise at least one base polymer or copolymer, at least one additional polymer or copolymer, and at least one nanoclay, the amount of base polymer can be any amount from about 25% to about 98% by weight of the composition of the peelable layer. The amount of base polymer can be, for example, about 25%, about 30%, about 35%, about 40%, about 45%, about 50%, about 55%, about 60%, about 65%, about 70%, about 72%, about 75%, about 80%, about 85%, about 88%, about 90%, about 95%, or about 98% by weight of the composition of the peelable layer. Preferably, the base polymer is from about 70% to about 90% by weight of the composition of the peelable layer, and is more preferably from about 72% to about 88% by weight of the composition of the peelable layer.

In embodiments comprising at least one additional polymer or copolymer, the additional polymer or copolymer can be any amount from about 1% to about 50% by weight of the composition of the peelable layer. The amount of additional polymer can be, for example, about 1%, about 2%, about 5%, about 10%, about 15%, about 20%, about 25%, about 30%, about 35%, about 40%, about 45%, or about 50% by weight of the composition of the peelable layer. Preferably, the amount of additional polymer is from about 5% to about 15% by weight of the composition of the peelable layer. In some particularly preferred embodiments, the amount of additional polymer or copolymer is about 10%, alternatively about 8%, alternatively about 9%, alternatively about 11% or alternatively about 12% by weight of the composition of the peelable layer.

Compositions for peelable layers and peelable films of the present technology also comprise at least one nanoclay. Nanoclay consists of montmorillonite, a clay mineral from the smectite family consisting of stacked silicate sheets that are about 2000 Å in length and 10 Å in thickness. Examples of commercially available nanoclays include, for example, Closite® Na⁺ from Southern Clay Products, and Nanoclays PGV® and PGW® from Nanocor.

One preferred type of nanoclay is an organically modified nanoclay, often referred to as organoclay. Organoclay is a natural montmorillonite clay that is treated with surfactants, such as, for example, quaternary ammonium salts. One particularly preferred source of organoclay is Southern Clay Products, Inc., part of Rockwood Specialties, Inc. in Princeton, N.J. Cloisite® additives consist of organically modified nanometer scale, layered magnesium aluminum silicate platelets. The silicate platelets that Cloisite® additives are derived from are 1 nanometer thick and about 70 to about 150 nanometers across. The platelets are surface modified with an organic chemistry to facilitate dispersion into and provide miscibility with the thermoplastic systems with which they were designed to be incorporated. Some particularly preferred types of organoclay for use with the present technology are, for example, Cloisite® 20A and Cloisite® 30B, available from Southern Clay Products, Inc. Both Cloisite® 20A and Cloisite® 30B are alkyl quaternary ammonium bentonites. Cloisite® 30B has a lower surface hydrophilicity than Cloisite® 20A.

The amount of nanoclay suitable for use with the present technology can vary depending upon the desired properties and characteristics of the peelable seal film or peelable film layer. In at least some embodiments, the amount of nanoclay can be any amount from about 1% to about 25% by weight of the composition of the peelable layer. For example, the nanoclay can be about 1%, about 3%, about 5%, about 10%, about 15%, about 20%, or about 25% by weight of the composition of the peelable layer. Preferably, the nanoclay is from about 5% to about 15%, or more preferably about 7% to about 13% by weight of the composition of the peelable layer. In some particularly preferred embodiments, the amount of nanoclay is about 7%, about 7.5%, about 8%, about 8.5%, about 9%, about 9.5%, about 10%, about 10.5%, about 11%, about 11.5%, about 12%, about 12.5%, about 13%, about 13.5%, about 14%, or about 14.5% by weight of the composition of the peelable layer.

In accordance with the discussion above, in at least one preferred embodiment, the present technology provides a peelable layer composition that comprises at least one base polymer or copolymer comprising a linear low density polyethylene (LLDPE), a low density polyethylene (LDPE), a medium density polyethylene (MDPE), an ethylene vinyl acetate (EVA), an ethyl methacrylate (EMA), an ethylene methacrylic acid polymer (EMAA), an ethylene acrylic acid (EAA), an ionomer, a high density polyethylene (HDPE), a single site catalyzed polymer, a plastomer, an ionomer, a blend thereof, or a mixture thereof; at least one additional polymer or copolymer comprising a linear low density polyethylene (LLDPE), an ultra low density polyethylene (ULDPE), a cyclic olefin copolymer (COC), a single site catalyzed polymer, a plastomer, an ionomer, a blend thereof, or a mixture thereof; and at least one nanoclay in an amount from about 1% to about 25% by weight of the peelable layer. In one embodiment, the at least one base polymer is from about 25% to about 95% by weight of the composition and the at least one additional polymer or copolymer is from about 1% to about 50% by weight of the peelable layer. In another embodiment, the at least one base polymer is from about 70% to about 90% by weight of the peelable layer, the at least one additional polymer or copolymer is from about 5% to about 15% by weight of the peelable layer, and the at least one nanoclay is in an amount from about 5% to about 15% by weight of the peelable layer.

Peelable layers of the present technology can also include one or more optional components, such as, for example, slip additives, antiblock additives, antifog additives, fillers, antistatic additives, color concentrates, colorants, pigments, dyes, flavorants, antimicrobial agents, meat preservatives, antioxidants, radiation stabilizers and process aids. Slip additives, for example, can consist of from about 1% to about 25% by weight of erucamide or oleamide or stearamide in a polyolefin carrier such as, for example, LLDPE, LDPE, polypropylene copolymer, a blend thereof, or a mixture thereof. As another example, antiblock additives can consist of from about 1% to about 60% by weight of silica, diatomaceous earth or talc in a polyolefin carrier such as, for example, LLDPE, LDPE, polypropylene copolymer, a blend thereof, or a mixture thereof. As a third example, color concentrates can consist of one or more pigments dispersed in a polyolefin carrier such as, for example, LLDPE, LDPE, copolymer, a blend thereof, or a mixture thereof.

### Peelable Film Structures

Peelable film structures of the present technology can be monolayer or multilayer structures. In monolayer film structures, the peelable layer of the film that provides the peelable feature comprises the entire thickness of the film. A preferred monolayer peelable film of the present technology is an extruded film. In multilayer structures, the peelable film comprises a peelable layer and at least one additional layer. In some embodiments, the peelable layer is coextruded with, or laminated to, at least one additional film layer. In other embodiments, the peelable layer can be extrusion coated onto a substrate. Peelable films of the present technology, whether monolayer or multilayer, can further be laminated to other films that can be monolayer or multilayer films.

With respect to monolayer embodiments of the present technology, the peelable layer is the only film layer. In preferred embodiments, the peelable layer is a sealant layer that forms a peelable seal with a substrate. Monolayer peelable films of the present technology can be incorporated into packages, or other applications, on their own. Alternatively, monolayer peelable films of the present technology can be extrusion coated onto a substrate, or laminated to anther film, and then be incorporated into packages, or other end use applications.

In some multilayer embodiments of the present technology, the peelable layer is an external or outer layer of the film. In some particularly preferred embodiments of this aspect of the present technology, the peelable layer is a sealant layer that forms a peelable seal with a substrate. The sealant layer is sometimes referred to as being the bottom layer of a film structure. For example, in some embodiments, the present technology provides a peelable seal film comprising at least one peelable sealant layer that forms a peelable seal, wherein the at least one peelable sealant layer comprises at least one base polymer or copolymer, and at least one nanoclay. Preferably, the at least one polymer or copolymer is selected from ethylene homopolymers, ethylene copolymers, propylene homopolymers, propylene copolymers, blends thereof, or mixtures thereof.

In some multilayer embodiments of the present technology, the peelable layer is an external or outer layer of the film that is not a sealant layer. In at least some such embodiments, the peelable layer can be the top or upper layer of a film, and can be peelably removed from the other film layers by the application of manual force. Films having a peelable upper layer preferably have a bottom sealant layer that forms a seal one or more substrates when the film is bonded to such substrates.

In other multilayer embodiments of the present technology, the peelable layer is an internal layer within the film structure. In such embodiments, the peelable layer can have any number of additional layers on either side of the peelable layer in the film structure. Films having a peelable internal layer within the film structure preferably have an outer sealant layer that forms a seal one or more substrates when the film is bonded to such substrates. In at least some such embodiments, the peelable layer, and any layers above the peelable layer in the film structure, can be peelably removed from the other film layers by the application of manual force.

Multilayer films of the present technology can have more than one peelable layer. For example, such embodiments preferably have at least two peelable layers. In such embodiments, a first peelable layer can be an outer layer, such as a sealant layer or an upper layer, or can be an internal layer within the film structure. Such embodiments can also have at least a second peelable layer that can be an outer layer, such as a sealant layer or an upper layer, or can be an internal layer within the film structure. In one example, a film of the present technology has a first peelable layer that is an upper layer or an internal layer of the film and can be peelably removed from the other film layers, and a second peelable layer that is a sealant layer that forms a peelable seal with a substrate.

Blown film, cast film, and extrusion coating processes are suitable for use in conjunction with making extruded peelable films and peelable layers of the present technology. For example, peeleable films and peelable film layers of the present technology can be produced as monolayer or multilayer films by blending, compounding, or mixing one or more nanoclays with at least one polymer or copolymer that can be an ethylene homopolymer, an ethylene copolymer, a propylene homopolymer, a propylene copolymer, a blend thereof, or a mixture thereof; and extruding the blend or mixture into a peelable film layer. Without being bound by any particular theory, it is believed that optimization of the peelable seal properties provided by peelable layers of the present technology can be obtained when the nanoclay is evenly dispersed throughout the at least one polymer or copolymer.

In at least one process suitable for making a peelable seal film of the present technology, the present technology provides a process for making a peelable film layer or extrusion coating comprising the steps of providing at least one nanoclay, providing at least one base polymer or copolymer, blending or compounding the at least one nanoclay and the at least one base polymer or copolymer to form a peelable blend; and extruding the peelable blend to form a peelable film layer or an extrusion coating. In another embodiment, the present technology provides a process for making a peelable film comprising the steps of providing at least one nanoclay, providing at least one base polymer or copolymer, blending or compounding the at least one nanoclay with the at least one base polymer or copolymer; further blending or compounding at least one additional polymer or copolymer with the at least one nanoclay with the at least one base polymer or copolymer to form a peelable blend; and extruding the peelable blend to form a peelable film, a peelable film layer, or an extrusion coating. In such processes, the peelable blend preferably comprises nanoclay in an amount from about 1% to about 25% by weight of the blend. In preferred embodiments of each of these processes, the process further comprises coextruding at least one additional film layer with the peelable film layer or extrusion coating. The products of such processes are examples of peelable seal films and film layers of the present technology.

In an alternative embodiment, the present technology provides a process for making a peelable film comprising the steps of providing at least one predispersed nanoclay comprising nanoclay dispersed in at least one polymer or copolymer, and extruding the predispersed nanoclay to form at least one peelable film layer or extrusion coating, wherein the at least one peelable film layer or extrusion coating comprises nanoclay in an amount from about 1% to about 25% by weight of the layer or coating. The at least one polymer or copolymer in the predispersed nanoclay can be referred to as a carrier polymer. In some such embodiments, the step of providing a predispersed nanoclay comprises providing at least one nanoclay, providing at least one base polymer or copolymer, and compounding or blending the nanoclay with the at least one base polymer or copolymer to form a predispersed nanoclay. In preferred embodiments, the process further comprises blending or compounding at least one additional polymer or copolymer with the predispersed nanoclay. In some embodiments, the process further comprises coextruding at least one additional layer with the peelable blend to form a peelable seal film or extrusion coating. In some preferred embodiments where the peelable layer is a sealant layer, the peelable layer can form a peelable seal with a substrate. The products of such processes are examples of peelable seal films and peelable layers of the present technology.

Additional layers that can be coextruded with or laminated to peelable layers of the present technology can be any film layer composition that is suitable based upon the desired application and properties of the film. Additional layers can be, for example, tie layers, barrier layers, sealant layers, or other suitable plastomeric layers.

Some preferred additional layers comprise polymers or copolymers that are the same or different from the polymers or copolymers in the peelable layer. In some such embodiments, for example, the sealant layer is coextruded with at least one additional layer that comprises at least one polymer or copolymer that is an ethylene homopolymer, ethylene copolymer, propylene homopolymer, propylene copolymer, blends thereof, or mixtures thereof. Some preferred embodiments of additional layers comprise a linear low density polyethylene (LLDPE), a low density polyethylene (LDPE), a medium density polyethylene (MDPE), an ethylene vinyl acetate (EVA), an ethylene methyl acrylate (EMA), an ethylene methacrylic acid polymer (EMAA), an ethylene acrylic acid (EAA), an ionomer, a high density polyethylene (HDPE), a polypropylene (PP), a polystyrene (PS), an elastomer, a styrene butadiene, a single site catalyzed polymer, a plastomer, an ionomer, a blend thereof, or a mixture thereof. Other preferred embodiments of an additional layer comprise a polyamide, an ethylene vinyl alcohol (EVOH), or a polyvinyl diene chloride (PVdC).

Peelable multilayer films of the present technology preferably have a peelable layer that is from about 1% to about 50% of the total thickness of the film. For example, the peelable layer can be about 5%, about 10%, about 12%, about 15%, about 20%, about 25%, about 30%, about 35%, about 40%, about 45%, or about 50% of the total thickness of the film. In some particularly preferred embodiments where the peelable layer is an external layer, the peelable layer is from about 5% to about 30%, preferably from about 5% to about 15%, or more preferably from about 8% to about 15%, of the total thickness of the film. In some particularly preferred embodiments where the peelable layer is an internal layer, the peelable layer is from about 3% to about 25%, preferably from about 4% to about 15%, or more preferably from about 5% to about 10%, of the total thickness of the film.

Peelable multilayer films of the present technology can comprise any number of layers, including, for example, from about 2 layers to about 10 layers, or greater than 10 layers. Some multilayer films of the present technology, for example, have 3 layers, 4 layers, 5 layers, 7 layers, 8 layers or 9 layers. In some multilayer embodiments, peelable layers of the present technology that form a peelable seal can be an outer layer, sometimes called an external layer, of the film. In other multilayer embodiments, the peelable layer that forms a peelable seal can be an internal layer within the film structure.

Some examples of preferred film structures are represented below. In each structure, types of individual film layers are represented by alphabetical symbols: A/D, A/C/D, A/B/D, A/B/C/D, A/C/B/D, A/B/C/E/D, A/E/C/E/D, A/B/E/C/D, A/C/B/E/D, A/C/E/B/D, A/E/B/C/D, A/E/C/B/D, A/C/B/C/D, A/B/C/B/D, A/B/C/E/B/D, A/B/C/E/C/D, A/B/E/C/B/D, A/C/E/C/B/D, A/B/C/B/B/D, A/C/B/B/B/D, A/C/B/C/B/D, A/C/E/B/B/D, A/B/E/C/E/B/D, A/B/E/C/E/B/E/D.

In the structures represented above, “A” is a sealant layer, “B” is a core or bulk layer, “C” is a barrier layer, “D” is an outside layer, and “E” is a tie layer. When a film structure below includes the same letter more than once, each occurrence of the letter represents the inclusion of the same type of film layer, although the composition of the layers may be the same or different. Peelable layers of the present technology can be “A” layers, “B” layers, “C” layers, or “D” layers.

Total film thicknesses suitable for use with the present technology can vary depending upon the end use application. In some embodiments, monolayer or multilayer peelable seal films of the present technology can be from about 0.3 mils to about 12 mils. In some embodiments, peelable seal films of the present technology are from about 0.3 mils to about 5 mils, or from about 0.3 mils to about 3 mils.

### Peelable Packages

Peelable packages of the present technology include, for example, packages incorporating a film having a peelable sealant layer, and packages incorporating a film having at least one peelable internal layer. Packages of the present technology can be used to contain any suitable material, including, for example, dry foods, aqueous foods, fresh foods, frozen foods, refrigerated foods, personal care items, agricultural products, and medical products. Some examples of dry foods include, but are not limited to, cereals, snacks, crackers, coffee, tea, cookies, chips, tortillas, confections, baked items, pasta, cake mixes, baking mixes, rice cakes, croutons, rice, dry pet food, condiments, flour, dried fruits, and nuts. Some examples of aqueous foods include, but are not limited to, beverages, puddings, gelatins, condiments, dips, soups, sauces, and wet pet food. Some examples of fresh foods include, but are not limited to, salads, vegetables, and fruits. Some examples of refrigerated foods include, for example, dairy products, juices, and meats. Some examples of frozen foods include, for example, waffles, pancakes, vegetables, pizza, prepared meals, meats and poultry. Some examples of agricultural products include, but are not limited to, mulch, soil, fertilizer, and chemicals such as insecticides, fungicides, etc. Some examples of personal care items include, but are not limited to, feminine hygiene products, diapers, and wipes. Some examples of medical products include, but are not limited to, medical devices, pharmaceuticals, gowns, table covers, and sponges.

In at least some embodiments, the present technology provides a package having a peelable seal. In at least some embodiments, such packages comprise at least one substrate that has at least one seal surface, and a peelable seal film comprising a peelable sealant layer. The peelable sealant layer preferably comprises at least one base polymer or copolymer selected from ethylene homopolymers, ethylene copolymers, propylene homopolymers, propylene copolymers, blends thereof, or mixtures thereof; and at least one nanoclay. In such embodiments, the peelable sealant layer can form a peelable seal with the at least one seal surface of at least one substrate.

In other embodiments, the present technology provides a package comprising at least one substrate comprising at least one seal surface; and a peelable film comprising at least one peelable internal layer. Peelable internal layers of the present technology preferably comprise at least one base polymer or copolymer selected from the group consisting of ethylene homopolymers, ethylene copolymers, propylene homopolymers, propylene copolymers, and blends thereof; and at least one nanoclay in an amount from about 1% to about 25% by weight of the peelable layer. In preferred embodiments of such packages, the peelable film can be bonded to the at least one seal surface of the substrate, and at least the peelable layer can be peelably removed by the exertion of manual force.

Examples of peelable packages of the present technology include, but are not limited to, trays, cups, bottles, blister packages, pouches, stand-up pouches, box liners, and bags. Packages such as trays, cups and blister packages are usually made from at least one substrate such as, for example, polystyrene or plastic. In such packages, the peelable film can be a lid or lid stock that is used to cover and seal an opening through which the package contents can be inserted and/or removed. Packages such as pouches, stand-up pouches, box liners, and bags are usually made from at least one substrate such as, for example, the peelable film itself, another film that can be a like film or a different film, a backing, a web, a flexible plastic, a rigid plastic, a polystyrene, or any other substrate suitable for the intended end use application. Some preferred substrates include, for example, substrates comprising polypropylene (PP), high density polypropylene (HDPE), and polyethylene terephthalate (PET). One example of such a substrate is a gas barrier cup with a PP, HDPE, or PET surface.

Peelable packaging in accordance with the present technology can be used in a variety of applications, such as packaging for food, medical, personal care, industrial, or agricultural items. Tray type packages are often used, for example, to contain food items such as fresh meat, prepared refrigerated and frozen foods, and other items. Cup type packages are often used, for example, to contain liquids, sliced fruit, snack foods, and other items. Bottles are often used to contain, for example, liquids, pills, and other items. Blister packages are often used, for example, to contain individual serving items such as pills, candies, lozenges, and other items. Stand-up pouches are often used, for example, to contain liquids, snack foods, coffee, and other items. Pouches and bags are often used, for example, to contain cereals, crackers, snack foods, coffee, salad greens and other produce, sterilized medical instruments, and other items. Box liners are often used, for example, in cereal and cracker packaging, and they are typically unprinted bags that contain product and are inserted into a box.

Peelable seals of the present technology can be formed by mechanical sealing, heat sealing, radio frequency sealing, or ultra-sonic sealing. Peelable seal packages of the present technology that include trays, cups, bottles or blister packages generally have at least one seal surface that is a lip, or a flange or other horizontal surface to which a peelable seal film can be bonded. For example, when the peelable layer of a peelable seal film of the present technology is an external sealant layer, a peelable seal can be formed by bonding the peelable sealant layer to the substrate. Peelable seal packages of the present technology that include pouches, stand-up pouches, box liners, and bags generally have at least one seal surface that is at least a portion of the substrate. For example, a pouch can be formed by folding a peelable seal film, and forming a peelable seal by bonding the peelable seal film to itself in a predetermined pattern that defines the outer limits of the inside of the pouch. In preferred embodiments of this type of package, the peelable layer of the film is an external sealant layer that is bonded to itself to form a peelable seal along at least one side of the package.

Peelable packages of the present technology can be designed to further facilitate opening in a variety of ways. For example, peelable films or peelable film layers can have a tab incorporated therein or attached thereto that can be grasped and pulled to open the seal. As another example, peelable films or peelable film layers can have a scored edge or other feature to aid in removal of the film or film layer. Alternatively, or in combination, the substrate to which a peelable film is bonded can have a scored edge or other feature to aid in removal of the peelable film or peelable film layer.

In some embodiments, peelable films of the present technology can be laminated to another film and then the laminate can be incorporated into a final package. In such embodiments, the other film can be used, for example, to provide mechanical properties, barrier properties, and/or printing properties. In other embodiments of peelable seal packages, the peelable seal film itself can comprise layers to provide such properties. Peelable seal film structures of the present technology can further be treated, surface printed, electronic beam (E-Beam) coated, fitted with a valve, or modified in other ways to obtain the desired package function and properties.

### Peelable Seal Properties

Peelable seal properties desired for various applications of peelable layers and films of the present technology can be achieved by optimizing the percentage of nanoclay in the peelable layer and the thickness and proportion of peelable layer. For example, the seal strength and hot tack of the peel seal can generally be increased in peelable layers of the present technology by incorporating at least one additional polymer or copolymer to the peelable layer composition. Suitable additional polymers or copolymers include, but are not limited to LLDPEs, ULDPEs, cyclic olefin copolymers (COC), single site catalyzed polymers, plastomers, ionomers, blends thereof, or mixtures thereof. Plastomers, for example, are particularly preferred for increasing hot tack. Hot tack is the strength of the heat seal immediately after sealing before it cools down to ambient temperature and achieves its final seal strength. Further, the seal strength of peelable seals of the present technology generally decreases as the percentage of nanoclay in the peelable layer increases. Additionally, as the thickness percentage of the peelable layer in the overall film structure decreases, the peel strength also tends to decrease.

As will be appreciated by those experienced in the art, the base polymers or copolymers described herein for use with the present technology, such as HDPE, for example, generally result in a film having a white or slightly off-white color. Discoloration of the film, i.e., additional coloration of the film in excess of the natural color provided by the base polymer or copolymer, is considered to be aesthetically undesirable in some applications. The addition of nanoclay into the peelable layer of peelable seal films of the present technology can result in the film exhibiting discoloration, such as, for example, the film exhibiting a yellowish or brownish coloration in excess of the natural color of the base polymer or copolymer. In particularly preferred embodiments of the present technology, the peelable layer and/or the peelable seal film, are the natural color of the base polymer or copolymer, or are only slightly tinted so as to avoid becoming aesthetically undesirable. For example, it has been found that discoloration does not occur with the use of Cloisite® 20A organoclays, available from Southern Clay Products, Inc.

The amount and/or type of nanoclay used in peelable layers and peelable seal films of the present technology can also affect the coefficient of friction (COF) of the peelable seal film. The COF is a unitless number and represents the ratio of the frictional force to a force acting vertically, usually gravitational force. COF is the measure of the relative difficulty with which the surface of one material will slide over an adjoining surface of itself or of another material. The static coefficient of friction is related to the force required to start the relative movement in between the surfaces, while the kinetic coefficient of friction is related to the force required to maintain the movement in between the surfaces. Preferably, COF can be measured in accordance with ASTM D1894. Both static and kinetic COF can be calculated using the following formula:

$$COF = \frac{Force required to slide one surface over another ( gf )}{Sled weight ( gf )}$$

In the formula above, the force used in calculating the static COF is the force required to start the relative movement in between the surfaces. The force used in calculating the kinetic COF is the force required to maintain the movement in between the surfaces.

In embodiments where the peelable layer of a film of the present technology is an external layer, the kinetic COF of the film is preferably from about 0.04 to about 1 when measured surface to surface. The COF is preferably, from about 0.06 to about 0.35, and is more preferably from about 0.1 to about 0.2 for applications on high speed packaging machines.

Without being bound by any particular theory, it is believed that the addition of nanoclay in the peelable layer of a peelable seal film may increase the barrier properties of the film with respect to moisture, solvents, chemical vapors, and/or gases such as oxygen. An improvement in barrier properties through the utilization of nanoclay has been observed in some other technologies. For example, improvement in the barrier properties of polymer systems used in microelectronics through the use of a polyimide-nanoclay hybrid has been studied by Yano K. et al., and is reported in “Synthesis and Properties of Polyimide-Clay Hybrid, Journal of Polymer Science Part A: Polymer Chemistry, Vol. 31 (1993), at pp. 2493-2498.

One preferred method of forming peelable seals of the present technology is by heat sealing. Peelable seals provided by the present technology have been surprisingly found to exhibit more uniform seal strength over a broad range of sealing temperatures as compared to other currently used technologies such as those incorporating polybutylene. Additionally, peelable seals of the present technology exhibit more consistent seal strength over time, also referred to as exhibiting less aging effect.

Seal strength can be determined by measuring the amount of force required to pull a formed seal apart. Seal strength is a property that is generally related to the heat seal temperature, the temperature at which the seal is formed. Seal strength generally has a starting value of 0 grams/inch at heat seal temperatures below the melting point of the base polymer of the sealant material. As the heat seal temperature increases past the melting point of the base polymer, the seal strength generally increases to a seal strength value that is maintained as the heat seal temperature increases within the heat seal window of the sealant material. The seal strength is generally considered to be best at sealing temperatures from about 220° F. to about 280° F., and the seal strength is therefore generally measured based upon heat seals formed within that range.

Seal strength can be tested and measured at the time a seal is formed, usually after a film or package is sealed at a given sealing temperature and is then cooled to room temperature. This property can be referred to as the green seal strength, and is preferably measured within about a minute of a newly formed peelable seal being cooled to room temperature. Although desirable green seal strength target values and ranges can vary depending upon the end use application of the peelable seal film or package, peelable seal films of the present technology preferably form a peelable seal with a substrate that has a seal strength of from about 200 grams/inch to about 3000 grams/inch when measured up to about 1 minute after the peelable seal is formed and cooled to room temperature. The preferred range for seal strength is about 500 gram/inch to 2000 gram/inch, or more preferably 800 gram/inch to 1600 gram/inch when measured up to about 1 minute after the peelable seal is formed and cooled to room temperature.

Seal strength can be also tested and measured after a seal has been formed and aged. This property is usually measured a number of days or weeks after the seal has been formed, and can be used to estimate the seal strength that a peelable seal has at the time that an end use consumer would open the peelable seal package. Aged seal strength can measured, for example, 7 days (1 week), 14 days (2 weeks), 21 days (3 weeks), or 30 days (4 weeks or one month) after the peelable seal has been formed. Similar to green seal strength, desirable aged seal strength target values and ranges can vary depending upon the end use application of the peelable seal film or package. For example, in at least some preferred embodiments, peelable seal films of the present technology form a peelable seal with a substrate that has a seal strength from about 200 grams/inch to about 3000 grams/inch as measured up to about 14 days after the peelable seal is formed. As another example, the seal strength of peelable seal films and packages used for certain food applications, such as containing cereal, are preferably from about 400 grams/inch to about 2000 grams/inch, and more preferably from about 800 grams/inch to about 1200 grams/inch. Other seal strength ranges and target values can be preferred for other end use applications.

The seal strength of some peelable seals tends to decrease over time. The change in seal strength is calculated on percentage basis with respect to the green seal strength and the aged seal strength. For example, in at least some preferred embodiments, peelable seal films of the present technology preferably form a peelable seal with a substrate that has a reduction in seal strength of about 15% or less, more preferably about 10% or less, in a time period of up to about one month.

The following examples provide testing and comparisons of peel seal properties of the present technology and of other technologies. The values provided in the examples below are approximate values. All percentages of compositional components are expressed in terms of percent by weight, unless otherwise indicated. The following examples are provided for illustrative purposes only, and are not meant to limit the scope of the claims appended hereto.

### EXAMPLE 1

### Effect of Percent Nanoclay on Peel Seal Strength

Two test films, Sample A and Sample B, were prepared having a peelable sealant layer and one additional layer. The peelable sealant layer of the test films was made by blending a base resin with nanoclay concentrate. The base resin consisted of an 18% vinyl acetate, 1.5 melt index (MI) EVA resin available from DuPont, having the tradename Elvax® 3169Z. The nanoclay concentrate consisted of 60% by weight nanoclay dispersed in a base polymer, available from PolyOne, having the tradename X150-258-102-3. The composition of the test films further contained 6% by weight of an additive mixture containing 5% by weight slip additive and 20% by weight antiblock additive, available from Polyfil, having the tradename POLYFIL® FSABC0520. The test films were formulated such that one had 6% by weight nanoclay in the sealant layer and the other had 9% by weight nanoclay in the sealant layer. The additional layer of the test films was a 1.0 MI HDPE resin, available from Chevron, having the tradename Marflex® 9659. Table 1 below summarizes several properties of the two test films.

TABLE 1
Properties of Test Samples A and B

| | Sealant | | Peel | |
|---|---|---|---|---|
| | Layer | | Seal Window, | COF |
| | Polymer | % Nanoclay | ° F. | (Sealant/Sealant) |
| Sample A | EVA | 6 | 190-300 | 0.938 |
| Sample B | EVA | 9 | 190-300 | 0.821 |

The seal strength of Sample A and Sample B was measured for sealing temperatures that varied in 10 degree increments from about 160° F. to about 300° F. Seal strength was measured within a minute after the Samples were sealed and cooled to room temperature. Table 2 below summarizes the measured seal strengths of sample A and B based upon the various sealing temperatures.

TABLE 2
Seal Strength of Test Samples A and B

| Sealing | Seal Strength | Seal Strength |
|---|---|---|
| Temperature | (grams/inch) | (grams/inch) |
| (° F.) | Sample A | Sample B |
| 170 | 46 | 19 |
| 180 | 209 | 150 |
| 190 | 518 | 381 |
| 200 | 1140 | 581 |
| 210 | 1197 | 673 |
| 220 | 1310 | 710 |
| 230 | 1227 | 680 |
| 240 | 1496 | 761 |
| 250 | 1234 | 776 |
| 260 | 1460 | 795 |
| 270 | 1239 | 815 |
| 280 | 1418 | 829 |
| 290 | 1476 | 877 |
| 300 | 1587 | 986 |

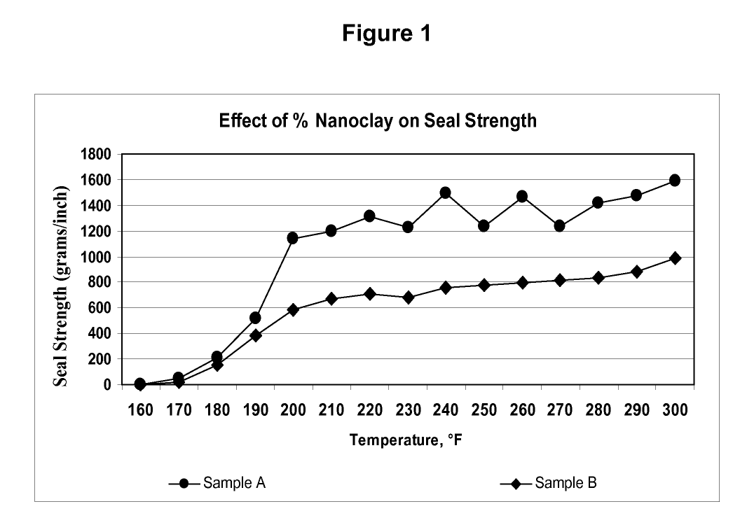

FIG. 1 is a graph showing the measured seal strengths of Sample A and Sample B. As shown in Table 2 and in FIG. 1, the seal strength of Sample B at each temperature was less than the seal strength of Sample A. This illustrates that the seal strength is inversely related to the amount of nanoclay in the sealant layer.

### EXAMPLE 2

### Polybutylene Technology Peel Seal Testing

In order to ascertain the scope of the aging effect in peelable seal films containing polybutylene, twenty five (25) commercially available peelable seal films, labeled as Films 1-25 in Table 2 below, that are supplied by Pliant Corporation to the dry food packaging market were evaluated for peel seal strength. Each of the tested sealant systems contained polybutylene, although the levels of polybutylene varied between sealant systems. It is generally believed that the aging effect of peel seal systems containing polybutylene is the result of a phase change in the crystallinity of the polybutylene molecule over time. Table 3 below shows the percentage of the seal strength loss as a percentage based upon a comparison of seal strength immediately after the seal was formed and cooled and seals of the same material that were fourteen (14) days old.

TABLE 3
Polybutylene Seal Strength Loss

| | | Polybutylene in |
|---|---|---|
| | Seal Strength | Sealant |
| Film | Loss (Percent) | (Percent) |
| 1 | 39% | 18% |
| 2 | 15% | 8% |
| 3 | 17% | 8% |
| 4 | 24% | 8% |
| 5 | 5% | 8% |
| 6 | 20% | 8% |
| 7 | 11% | 8% |
| 8 | 25% | 8% |
| 9 | 51% | 9% |
| 10 | 41% | 9% |
| 11 | 57% | 15% |
| 12 | 15% | 10% |
| 13 | 59% | 20% |
| 14 | 20% | 10% |
| 15 | 19% | 10% |
| 16 | 30% | 9% |
| 17 | 40% | 9% |
| 18 | 47% | 9% |
| 19 | 48% | 10% |
| 20 | 45% | 10% |
| 21 | 23% | 12% |
| 22 | 40% | 15% |
| 23 | 16% | 9% |
| 24 | 18% | 10% |
| 25 | 41% | 18% |

Film number 5 had the lowest percentage of seal strength loss, at 5%. Film number 13 had the highest percentage of seal strength loss, at 59%. The average percentage of seal strength loss over fourteen (14) days by the tested films containing polybutylene was 31%.

### EXAMPLE 3

### Comparison of Peel Seal Strength of Nanoclay Based Sealant Layer to Polybutylene Technology

Four different two layer film samples (Samples C through F), having a peelable sealant layer coextruded with an HDPE layer, were prepared for testing.

Sample C was a polybutylene containing film sample prepared by blending 74% by weight of an 18% vinyl acetate, 1.5 MI resin available from DuPont, having the tradename Elvax® 3169Z; 9% by weight of a polybutylene from Basell, having the tradename Polybutylene-1® PB1600AM; 10% by weight of an metallocene-catalyzed LLDPE (mLLDPE) from Exxon, having the tradename Exact® 3132; 5% by weight of an additive mixture (2.5% slip additive and 25% antiblock additive) available from Polyfil, having the tradename SSABC2525; and 2% by weight of an additive mixture (5% slip additive) available from Ampacet, having the tradename 10090. The other layer was made from a 1.0 MI HDPE resin from Chevron, having the tradename Marflex® 9659.

Samples D, E & F were film samples prepared by blending 72% by weight, 70% by weight and 68% by weight, respectively, of an 18% vinyl acetate, 2.5 MI resin from DuPont, having the tradename Elvax® 3170SHB; nanoclay concentrate (60% by weight nanoclay in a base polymer) from PolyOne, having the tradename MB230-615; 10% by weight mLLDPE from Exxon, having the tradename Exact® 3132; 6% by weight of an additive mixture (5% slip additive and 25% antiblock additive) from Polyfil, having the tradename FSABC0525. The nanoclay concentrate was added to the sealant film compositions of Samples D, E and F at 12%, 14% and 16% by weight, respectively, such that the final film of Sample D had nanoclay content of 7.2% by weight, the final film of Sample E had nanoclay content of 8.4% by weight, and the final film of Sample F had nanoclay content of 9.6% by weight. The other layer for each sample was a 1.0 Ml HDPE resin from Chevron, having the tradename Marflex® 9659. Table 4 below summarizes several properties of the four test films.

TABLE 4
Comparison of films based of Polybutylene and Nanoclay

| | Sealant | % Polybutylene | | |
|---|---|---|---|---|
| | Layer | (PB) or | Peel Seal | COF |
| | Polymer | Nanoclay | Window, ° F. | (Sealant/Sealant) |
| Sample C | EVA | 9.0% PB | 190-300 | 0.09 |
| Sample D | EVA | 7.2% Nanoclay | 190-300 | 0.87 |
| Sample E | EVA | 8.4% Nanoclay | 190-300 | 0.772 |
| Sample F | EVA | 9.6% Nanoclay | 190-300 | 0.755 |

The seal strength of Samples C, D, E and F was measured for sealing temperatures in 20 degree increments from about 170° F. to about 300° F. at 0 Time (within a minute after the peelable seal was formed and cooled to room temperature) and after 1 Month (30 days). Tables 5-8 below provide listings of the seal strengths as measured for Samples C—F, respectively. Tables 5-8 also provide the percentage of seal strength lost between the 0 Time measurement and the 1 Month measurement for each sealing temperature.

TABLE 5
Measured Seal Strengths of Sample C (9% PB)

| | | | |
|---|---|---|---|
| | 0 Time | 1 Month | Seal Strength |
| Temperature | Seal Strength | Seal Strength | Loss |
| (° F.) | (grams/inch) | (grams/inch) | (Percent) |

| | | | |
|---|---|---|---|
| 170 | 23 | 11 | 52.1% |
| 190 | 176 | 132 | 25% |
| 210 | 355 | 531 | −49.5% |
| 230 | 602 | 657 | −9.1% |
| 250 | 1112 | 1029 | 7.4% |
| 270 | 1321 | 1134 | 14.1% |
| 290 | 1404 | 884 | 37% |
| 300 | 1613 | 1305 | 19% |

TABLE 6
Measured Seal Strengths of Sample D (7.2% Nanoclay)

| | 0 Time Seal | 1 Month Seal | Seal Strength |
|---|---|---|---|
| Temperature | Strength | Strength | Loss |
| (° F.) | (grams/inch) | (grams/inch) | (Percent) |
| 170 | 6 | 13 | −116% |
| 190 | 115 | 156 | −35.6% |
| 210 | 460 | 472 | −2.6% |
| 230 | 902 | 748 | 17% |
| 250 | 1011 | 888 | 12.2% |
| 270 | 1041 | 1016 | 2.4% |
| 290 | 1139 | 1024 | 10.1% |
| 300 | 1236 | 1384 | −12% |

TABLE 7
Measured Seal Strengths of Sample E (8.4% Nanoclay)

| | 0 Time Seal | 1 Month Seal | Seal Strength |
|---|---|---|---|
| Temperature | Strength | Strength | Loss |
| (° F.) | (grams/inch) | (grams/inch) | (Percent) |
| 170 | 20 | — | — |
| 190 | 88 | 158 | −79.5% |
| 210 | 399 | 429 | −7.5% |
| 230 | 600 | 647 | −7.8% |
| 250 | 705 | 791 | −12.2% |
| 270 | 826 | 755 | 8.6% |
| 290 | 819 | 937 | −14.4% |
| 300 | 1325 | 1285 | 2.9% |

TABLE 8
Measured Seal Strengths of Sample F (9.6% Nanoclay)

| | 0 Time Seal | 1 Month Seal | Seal Strength |
|---|---|---|---|
| Temperature | Strength | Strength | Loss |
| (° F.) | (grams/inch) | (grams/inch) | (Percent) |
| 170 | 7 | — | — |
| 190 | 132 | 63 | 52.3% |
| 210 | 477 | 376 | 21.2% |
| 230 | 582 | 581 | 0.17% |
| 250 | 666 | 578 | 13.2% |
| 270 | 721 | 770 | −6.8% |
| 290 | 728 | 824 | −13.2% |
| 300 | 1130 | 1396 | −23.5% |

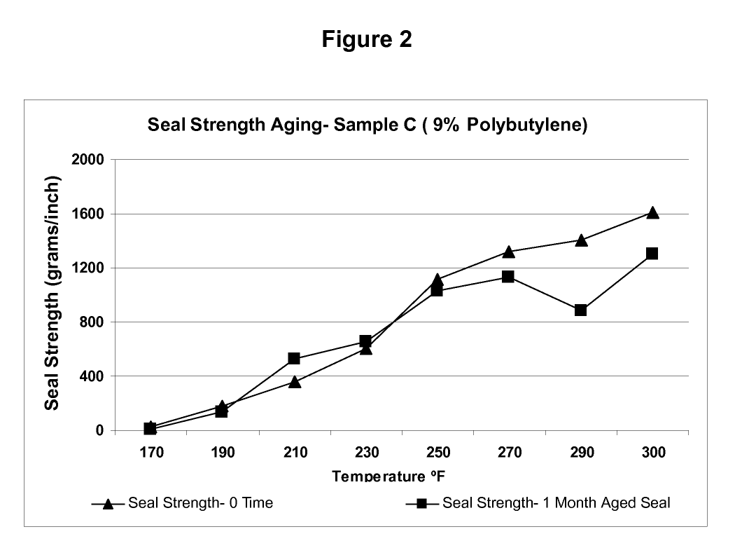

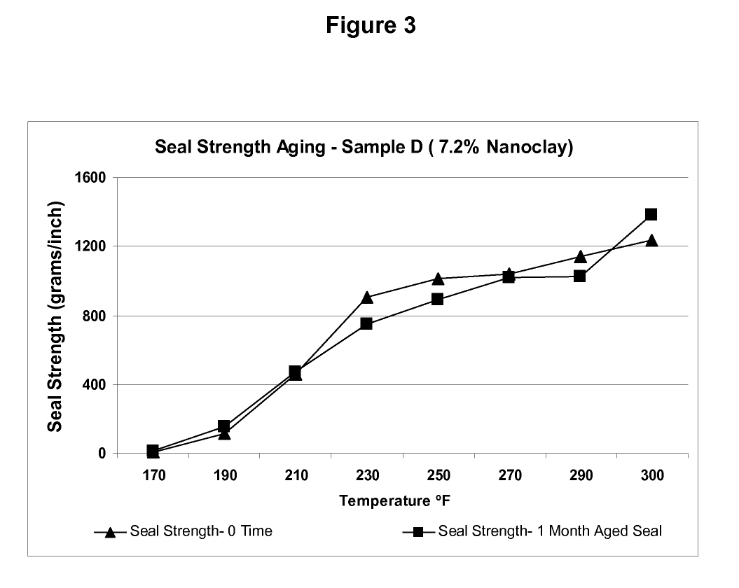

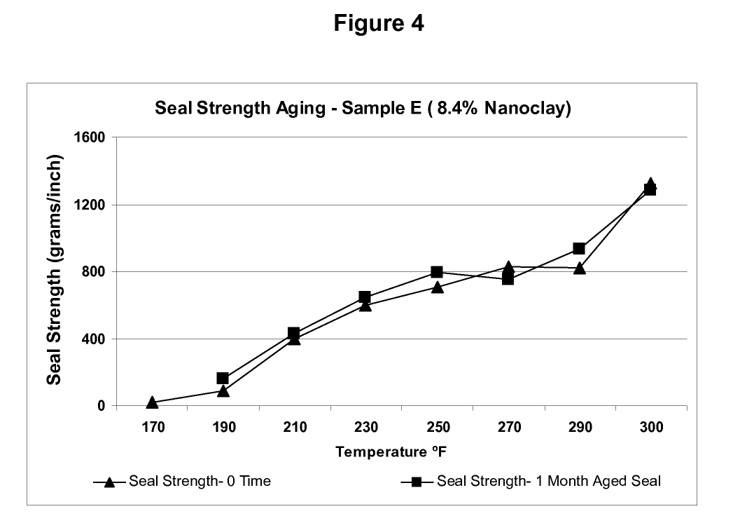

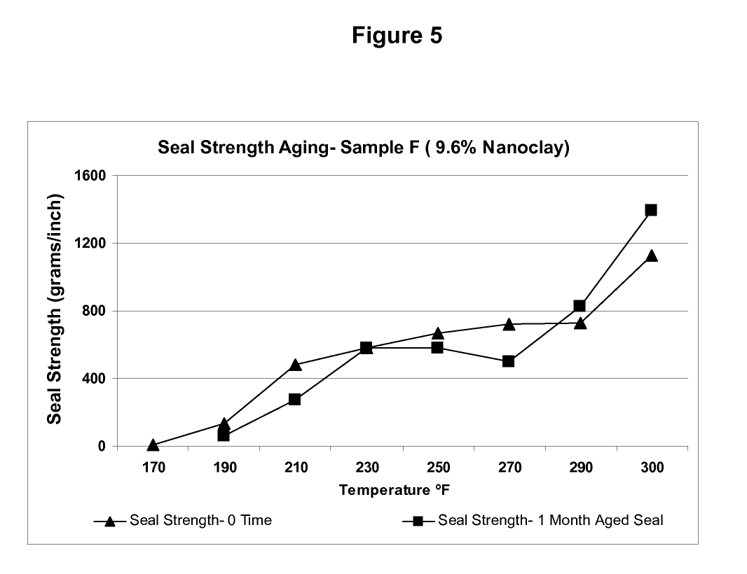

FIG. 2 is a graph showing the measured seal strengths of Sample C at 0 Time and 1 Month for each sealing temperature. FIG. 3 is a graph showing the measured seal strengths of Sample D at 0 Time and 1 Month for each sealing temperature. FIG. 4 is a graph showing the measured seal strengths of Sample E at 0 Time and 1 Month for each sealing temperature. FIG. 5 is a graph showing the measured seal strengths of Sample F at 0 Time and 1 Month for each sealing temperature.

### EXAMPLE 3

### COF and Coloration

Film samples A, B, D, E and F all had relatively high coefficients of friction and had a slightly tinted coloration. Additional film formulations were developed and made into films (Samples G-I) that had lower coefficients of friction and no discoloration.

A first predispersed nanoclay concentrate was made by melt blending 9% by weight of an organoclay from Southern Clay Products, Inc., having the tradename Cloisite® 20A, with 91% by weight of 18% vinyl acetate, 0.7 MI EVA resin available from DuPont, having the tradename Elvax® 3165, in a co-rotating twin screw extruder at a temperature of about 375° F. and a screw speed of 200 rpm.

A second predispersed nanoclay concentrate was made by melt blending 9% by weight of an organoclay from Southern Clay Products, Inc., having the tradename Cloisite® 20A, with 91% by weight of 18% vinyl acetate, 2.5 MI EVA resin available from DuPont, having the tradename Elvax® 3170, in a co-rotating twin screw extruder at a temperature of about 375° F. and a screw speed of 200 rpm.

A third predispersed nanoclay concentrate was made by melt blending 9% by weight of an organoclay from Southern Clay Products, Inc., having the tradename Cloisite® 30B, with 91% by weight of 18% vinyl acetate, 0.7 MI EVA resin available from DuPont, having the tradename Elvax® 3165, in a co-rotating twin screw extruder at a temperature of about 375° F. and a screw speed of 200 rpm.

A fourth predispersed nanoclay concentrate was made by melt blending 9% by weight of an organoclay from Southern Clay Products, Inc., having the tradename Cloisite® 30B, with 91% by weight of 18% vinyl acetate, 2.5 MI EVA resin available from DuPont, having the tradename Elvax® 3170, in a co-rotating twin screw extruder at a temperature of about 375° F. and a screw speed of 200 rpm.

Sample G was a two layer film sample having a peelable sealant layer and a layer made from a 1.0 MI HDPE resin from Chevron, having the tradename Marflex® 9659. The peelable layer was made by the blending first predispersed nanoclay concentrate with 10% by weight of an mLLDPE available from Exxon, having the tradename 3132, and 3.6% by weight of an additive mixture (20% slip additive) from Ampacet, having the tradename 101724U. The final sealant layer contained about 7.8% by weight nanoclay. Sample G exhibited no discoloration and had a COF of 0.25.

Sample H was a two layer film sample having a peelable sealant layer and a layer made from a 1.0 MI HDPE resin from Chevron, having the tradename Marflex® 9659. The peelable layer was made by blending the second predispersed nanoclay concentrate with 10% by weight of an mLLDPE available from Exxon, having the tradename 3132, and 3.6% by weight of an additive mixture (20% slip additive) from Ampacet, having the tradename 101724U. The final sealant layer contained about 7.8% by weight nanoclay. Sample H exhibited no discoloration and had a COF of 0.20.

Sample I was a two layer film sample having a peelable sealant layer and a layer made from a 1.0 MI HDPE resin from Chevron, having the tradename Marflex® 9659. The peelable layer was made by blending the third predispersed nanoclay concentrate with 10% by weight of an mLLDPE available from Exxon, having the tradename 3132, and 3.6% by weight of an additive mixture (20% slip additive) from Ampacet, having the tradename 101724U. The final sealant layer contained about 7.8% by weight nanoclay. Sample I exhibited no discoloration and had a COF of 0.25.

Sample J was a two layer film sample having a peelable sealant layer and a layer made from a 1.0 MI HDPE resin from Chevron, having the tradename Marflex® 9659. The peelable layer was made by blending the fourth predispersed nanoclay concentrate with 10% by weight of an mLLDPE available from Exxon, having the tradename 3132, and 3.6% by weight of an additive mixture (20% slip additive) from Ampacet, having the tradename 101724U. The final sealant layer contained about 7.8% by weight nanoclay. Sample J exhibited no discoloration and had a COF of 0.22.

### EXAMPLE 4

### Evaluation of Nanoclay Based Peelable Films

Eight sample films were prepared for testing. Samples G-J were prepared for testing as described above. Samples K-N, having varying levels of nanoclay in the final sealant layers, were prepared using the “second predispsersed nanoclay concentrate” described above.

Sample K was a two layer film sample having a peelable sealant layer and a layer made from a 1.0 MI HDPE resin from Chevron, having the tradename Marflex® 9659. The sealant layer was prepared by first providing about 32% by weight of a nanoclay concentrate containing 40% by weight of a nanoclay available from Southern Clay, having the tradename Cloisite® 20A, in an 18% vinyl acetate 2.5 MI EVA resin from Dupont, having the tradename Elvax® 3170. The nanoclay concentrate was blended with 10% by weight of an mLLDPE available from Exxon, having the tradename Exact® 3132, and 1.0% of an additive mixture (20% by weight slip additive) available from Ampacet, having the tradename 101724U. The final sealant layer had nanoclay content of about 12.8% by weight.

Sample L was a two layer film sample having a peelable sealant layer and a layer made from a 1.0 MI HDPE resin from Chevron, having the tradename Marflex® 9659. The sealant layer was prepared by first providing about 22.5% by weight of a nanoclay concentrate containing 40% by weight of nanoclay available from Southern Clay, having the tradename Cloisite® 20A, in an 18% vinyl acetate 2.5 MI EVA resin from Dupont, having the tradename Elvax® 3170. The nanoclay concentrate was blended with 10% by weight of an mLLDPE available from Exxon, having the tradename Exact® 3132, and 3.6% of an additive mixture (20% by weight slip additive) available from Ampacet, having the tradename 101724U. The final sealant layer had nanoclay content of about 9% by weight.

Sample M was a two layer film sample having a peelable sealant layer and a layer made from a 1.0 MI HDPE resin from Chevron, having the tradename Marflex® 9659. The sealant layer was prepared by first providing about 25% by weight of a nanoclay concentrate containing 40% by weight of nanoclay available from Southern Clay, having the tradename Cloisite® 20A, in an 18% vinyl acetate 2.5 MI EVA resin from Dupont, having the tradename Elvax® 3170. The nanoclay concentrate was blended with 10% by weight of an mLLDPE available from Exxon, having the tradename Exact® 3132, and 3.6% of an additive mixture (20% by weight slip additive) available from Ampacet, having the tradename 101724U. The sealant final sealant layer had nanoclay content of about 10% by weight.

Sample N was a two layer film sample having a peelable sealant layer and a layer made from a 1.0 MI HDPE resin from Chevron, having the tradename Marflex® 9659. The sealant layer was prepared by first providing about 32% by weight of a nanoclay concentrate containing 40% by weight of nanoclay available from Southern Clay, having the tradename Cloisite® 20A, in an 18% vinyl acetate 2.5 MI EVA resin from Dupont, having the tradename Elvax® 3170. The nanoclay concentrate was blended with 10% by weight of a COC available from TOPAS, having a tradename TOPAS® 8007, and 3.6% of an additive mixture (20% by weight slip additive) available from Ampacet, having the tradename 101724U. The final sealant layer contained about 12.8% by weight nanoclay.

Table 9 below summarizes several properties of the eight test films.

TABLE 9
Comparison of films based of different Nanoclay and different EVA

| | Sealant | | | |
|---|---|---|---|---|
| | Layer | Nanoclay | Peel Seal | COF |
| | Polymer | % By Weight | Window ° F. | (Sealant/Sealant) |
| Sample G | EVA | 7.8 | 190-300 | 0.25 |
| Sample H | EVA | 7.8 | 190-300 | 0.20 |
| Sample I | EVA | 7.8 | 190-300 | 0.25 |
| Sample J | EVA | 7.8 | 190-300 | 0.22 |
| Sample K | EVA | 12.8 | 190-300 | 0.144 |
| Sample L | EVA | 9.0 | 190-300 | 0.341 |
| Sample M | EVA | 10.0 | 190-300 | 0.235 |
| Sample N | EVA | 12.8 | 190-300 | 0.195 |

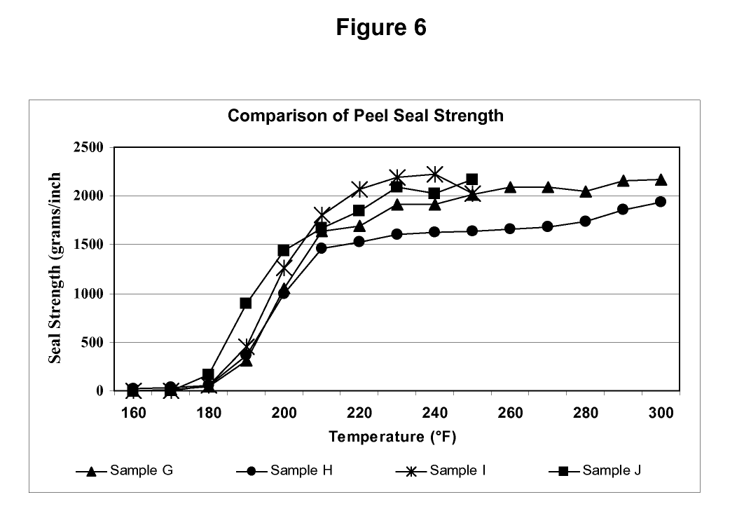

The seal strength of Samples G and H was tested for seal strengths having 10 degree increments from about 160° F. to about 300° F. The samples were sealed at the indicated temperature and the seal strength was measured within one minute of the film being cooled to room temperature after the seal was formed. The seal strength of Samples I and J was tested for seal strengths having 10 degree increments from about 160° F. to about 250° F. The samples were sealed at the indicated temperature and the seal strength was measured within one minute of the film being cooled to room temperature after the seal was formed. FIG. 6 is a graph of the peel strength testing for Samples G-J.

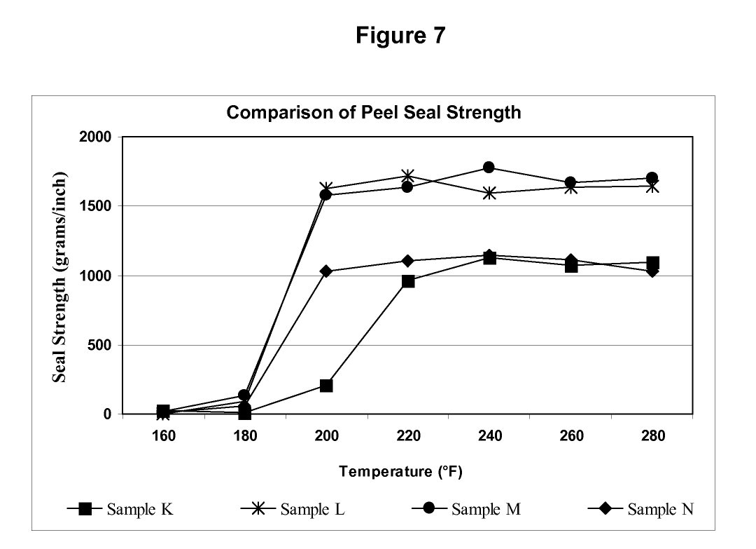

The seal strength of Samples K through N was tested for sealing temperatures of 20 degree increments from about 160° F. to about 280° F. The samples were sealed at the indicated temperature and the seal strength was measured within one minute of the film being cooled to room temperature after the seal was formed. FIG. 7 is a graph of the peel strength testing for Samples K-N. The seal strength of Samples L and M, having nanoclay contents of about 9% by weight and about 10% by weight, respectively, were consistently higher than that of Samples K and N, having nanoclay contents of about 12.8% by weight each.

The invention has now been described in such full, clear, concise and exact terms as to enable any person skilled in the art to which it pertains, to practice the same. It is to be understood that the foregoing describes preferred embodiments and examples of the invention and that modifications may be made therein without departing from the spirit or scope of the invention as set forth in the claims.

What is claimed is:

1. A peelable film layer comprising:
at least one base polymer or copolymer comprising an ethylene homopolymer, an ethylene copolymer, a propylene homopolymer, a propylene copolymer, a blend thereof, or a mixture thereof; and
at least one nanoclay in an amount from about 1% to about 25% by weight of the peelable film layer.

2. The film layer of claim 1, wherein the peelable film layer forms a peelable seal with a substrate.

3. The film layer of claim 1, wherein the substrate comprises the peelable layer, another peelable layer, another film, a polystyrene, a polypropylene, a high density polyethylene, or a polyethylene terephthalate.

4. The film layer of claim 1, wherein the nanoclay is from about 5% to about 15% by weight of the film layer.

5. The film layer of claim 3, wherein the nanoclay is from about 7% to about 13% by weight of the film layer.

6. The film layer of claim 1, wherein the base polymer or copolymer comprises a linear low density polyethylene, a low density polyethylene, a medium density polyethylene, an ethylene vinyl acetate, an ethylene methyl acrylate, an ethylene methacrylic acid polymer, an ethylene acrylic acid, an ionomer, a high density polyethylene, a polypropylene, a single site catalyzed polymer, a plastomer, an ionomer, a blend thereof, or a mixture thereof.

7. The film layer of claim 1, further comprising at least one additional polymer or copolymer comprising a linear low density polyethylene, an ultra low density polyethylene, a cyclic olefin copolymer, a single site catalyzed polymer, a plastomer, an ionomer, a blend thereof, or a mixture thereof.

8. The film layer of claim 1, comprising:
at least one base polymer or copolymer comprising a linear low density polyethylene, a low density polyethylene, a medium density polyethylene, an ethylene vinyl acetate, an ethylene methyl acrylate, an ethylene methacrylic acid polymer, an ethylene acrylic acid, a high density polyethylene, a polypropylene, a single site catalyzed polymer, a plastomer, an ionomer, a blend thereof, or a mixture thereof;
at least one additional polymer or copolymer comprising a linear low density polyethylene, an ultra low density polyethylene, a cyclic olefin copolymer, a single site catalyzed polymer, a plastomer, an ionomer, a blend thereof, or a mixture thereof; and
at least one nanoclay in an amount from about 1% to about 25% by weight of the film layer;
wherein the at least one base polymer or copolymer is from about 25% to about 95% by weight of the film layer; and
wherein the second polymer or copolymer is from about 1% to about 50% by weight of the film layer.

9. The film layer of claim 8, wherein the at least one base polymer is from about 70% to about 90% by weight of the film layer, the at least one additional polymer or copolymer is from about 5% to about 15% by weight of the film layer, and the at least one nanoclay is from about 5% to about 15% by weight of the film layer.

10. A peelable film comprising:
at least one peelable layer, wherein the at least one peelable layer comprises at least one base polymer or copolymer, and at least one nanoclay;
wherein the at least one polymer or copolymer is selected from the group consisting of ethylene homopolymers, ethylene copolymers, propylene homopolymers, propylene copolymers, and blends thereof; and
wherein the at least one nanoclay is from about 1% to about 25% by weight of the peelable layer.

11. The peelable film of claim 10, wherein the nanoclay is from about 5% to about 15% by weight of the composition.

12. The peelable film of claim 10, wherein the nanoclay is from about 7% to about 13% by weight of the composition.

13. The peelable film of claim 10, wherein the peelable layer forms a peelable seal with a substrate comprising the peelable layer of the film, another peelable layer, another film, a polystyrene, a polypropylene, a high density polyethylene, or a polyethylene terephthalate.

14. The peelable film of claim 13, wherein the peelable seal is formed by mechanical sealing, heat sealing, radio frequency sealing, or ultra-sonic sealing.

15. The peelable film of claim 10, wherein the base polymer or copolymer comprises a linear low density polyethylene, a low density polyethylene, a medium density polyethylene, an ethylene vinyl acetate, an ethylene methyl acrylate, an ethylene methacrylic acid polymer, an ethylene acrylic acid, an ionomer, a high density polyethylene, a polypropylene, a single site catalyzed polymer, a plastomer, an ionomer, a blend thereof, or a mixture thereof.

16. The peelable film of claim 10, further comprising at least one additional polymer or copolymer comprising a linear low density polyethylene, an ultra low density polyethylene, a cyclic olefin copolymer, a single site catalyzed polymer, a plastomer, an ionomer, a blend thereof, or a mixture thereof.

17. The peelable film of claim 10, wherein the film is extrusion coated or coextrusion coated onto a substrate.

18. The peelable film of claim 10, wherein the film is a monolayer film.

19. The peelable film of claim 10, wherein the film is a multilayer film.

20. The peelable film of claim 19, wherein the at least one peelable layer is coextruded with at least one additional film layer.

21. The peelable film of claim 19, wherein the at least one peelable layer is laminated to at least one additional film layer.

22. The peelable film of claim 19, wherein the peelable layer has a thickness of from about 5% to about 30% of the total thickness of the film.

23. The peelable film of claim 19, wherein the peelable layer has a thickness of from about 8% to about 20% of the total thickness of the film.

24. The peelable film of claim 10, wherein the film forms a peelable seal with a substrate, and the peelable seal having a seal strength of from about 200 grams/inch to about 3000 grams/inch as measured up to about 1 minute after the peelable seal is formed and cooled to room temperature.

25. The peelable film of claim 10, wherein the film forms a peelable seal with a substrate, and the peelable seal having a seal strength of from about 400 grams/inch to about 2000 grams/inch as measured up to about 1 minute after the peelable seal is formed and cooled to room temperature.

26. The peelable film of claim 10, wherein the film forms a peelable seal with a substrate, and the peelable seal having a seal strength of from about 200 grams/inch to about 3000 grams/inch as measured up to about 14 days after the peelable seal is formed.

27. The peelable film of claim 10, wherein the film forms a peelable seal with a substrate, and the peelable seal having a seal strength of from about 400 grams/inch to about 2000 grams/inch as measured up to about 1 minute after the peelable seal is formed.

28. The peelable film of claim 10, wherein the film forms a peelable seal with a substrate, having a seal strength that has a reduction in seal strength of about 15% or less in a time period of up to about a month.

29. The peelable film of claim 28, wherein the film forms a peelable seal with a substrate, having a seal strength that has a reduction in seal strength of about 10% or less in a time period of up to about a month.

30. The peelable film of claim 10, wherein the peelable layer is the natural color of the base polymer or copolymer.

31. The peelable film of claim 10, wherein the film has a coefficient of friction of from about 0.04 to about 1.

32. The peelable film of claim 10, wherein the film has a coefficient of friction of from about 0.06 to about 0.35.

33. The peelable film of claim 10, wherein the film has a coefficient of friction of from about 0.1 to about 0.2.

34. A process for making a peelable film comprising the steps of:
providing at least one nanoclay;
providing at least one base polymer or copolymer;
blending or compounding the at least one nanoclay and the at least one base polymer or copolymer to form a peelable blend comprising nanoclay in an amount from about 1% to about 25% by weight of the blend; and
extruding the peelable blend to form at least one peelable film layer or extrusion coating.

35. The process of claim 34, further comprising blending or compounding at least one additional polymer or copolymer with the at least one nanoclay and the at least one base polymer or copolymer to form a peelable blend comprising nanoclay in an amount from about 1% to about 25% by weight of the blend.

36. The process of claim 34, further comprising coextruding at least one additional layer with the peelable blend to form a peelable seal film or extrusion coating.

37. The peelable film layer or extrusion coating product of the process of claim 34.

38. A process for making a peelable seal film comprising the steps of:
providing at least one predispersed nanoclay comprising nanoclay dispersed in at least one polymer or copolymer; and
extruding the predispersed nanoclay to form at least one peelable film layer or extrusion coating, wherein the at least one peelable film layer or extrusion coating comprises nanoclay in an amount from about 1% to about 25% by weight of the layer or coating.

39. The process of claim 38, wherein the step of providing a predispersed nanoclay comprises:
providing at least one nanoclay;
providing at least one base polymer or copolymer; and
compounding the nanoclay with the at least one base polymer or copolymer to form a predispersed nanoclay.

40. The process of claim 38, further comprising coextruding at least one additional layer with the peelable blend to form a peelable seal film or extrusion coating.

41. The process of claim 38, wherein the peelable film or peelable film layer forms a peelable seal with a substrate.

42. The process of claim 38, further comprising blending or compounding at least one additional polymer or copolymer with the predispersed nanoclay.

43. The peelable film product produced according to the process of claim 38.

44. A package having a peelable seal, the package comprising:
at least one substrate comprising at least one seal surface; and
at least one peelable seal film comprising a peelable sealant layer, wherein the peelable sealant layer comprises:
at least one base polymer or copolymer comprising an ethylene homopolymer, an ethylene copolymer, a propylene homopolymer, a propylene copolymer, or a blend thereof; and
at least one nanoclay in an amount from about 1% to about 25% by weight of the sealant layer;
wherein the peelable sealant layer of the peelable seal film forms a peelable seal with the at least one seal surface of the substrate.

45. The package of claim 44, wherein the nanoclay is from about 5% to about 15% by weight of the sealant layer.

46. The package of claim 45, wherein the nanoclay is from about 7% to about 13% by weight of the sealant layer.

47. The peelable seal package of claim 44, wherein the peelable seal has a seal strength from about 200 grams/inch to about 3000 grams/inch as measured up to about 1 minute after the peelable seal is formed.

48. The peelable seal package of claim 44, wherein the peelable seal has a seal strength from about 400 grams/inch to about 2000 grams/inch as measured up to about 1 minute after the peelable seal is formed.

49. The peelable seal package of claim 44, wherein the peelable seal has a seal strength from about 200 grams/inch to about 3000 grams/inch as measured up to about 14 days after the peelable seal is formed.

50. The peelable seal package of claim 44, wherein the peelable seal has a seal strength from about 400 grams/inch to about 2000 grams/inch as measured up to about 1 minute after the peelable seal is formed.

51. The peelable seal package of claim 44, wherein the peelable seal has a seal strength that has a reduction in seal strength of about 15% or less in a time period of up to about a month.

52. The peelable seal package of claim 44, wherein the peelable seal has a seal strength that has a reduction in seal strength of about 10% or less in a time period of up to about a month.

53. A package comprising:
at least one substrate comprising at least one seal surface; and
a peelable film comprising at least one peelable internal layer, wherein the peelable internal layer comprises:
at least one base polymer or copolymer selected from the group consisting of ethylene homopolymers, ethylene copolymers, propylene homopolymers, propylene copolymers, and blends thereof; and
at least one nanoclay in an amount from about 1% to about 25% by weight of the peelable layer;
wherein the peelable film is bonded to the at least one seal surface of the substrate; and
wherein at least the peelable layer can be peelably removed by the exertion of manual force.

54. The package of claim 53, wherein the nanoclay is from about 5% to about 15% by weight of the peelable layer.

55. The package of claim 53, wherein the nanoclay is from about 7% to about 13% by weight of the peelable layer.
